(19) United States
(12) Patent Application Publication
(10) Pub. No.: US 2016/0186014 A1
(43) Pub. Date: Jun. 30, 2016

(54) MATERIAL FOR COVERING ADHESIVE SURFACES

(71) Applicant: GETING SOLUTIONS GMBH, Herrenberg (DE)

(72) Inventors: Joachim Leipold, Reutlingen (DE); Edgar Jaeschke, Filderstadt (DE); Fabian Haferkamp, Stuttgart (DE)

(21) Appl. No.: 14/906,230

(22) PCT Filed: Jul. 2, 2014
(86) PCT No.: PCT/EP2014/064061

§ 371 Date: Jan. 19, 2016

(30) Foreign Application Priority Data
Jul. 18, 2013 (DE) 10 2013 107 665.3

(51) Int. Cl. C09J 7/02

(52) U.S. Cl. CPC C09J 7/0232

(57) ABSTRACT

The use of a material for covering adhesive layers, which material can then be redetached from the adhesive layer substantially without leaving any residues, the material having an essentially smooth surface with outward and/or inward facing structures distributed over the surface, the outward and/or inward facing structures being statistically distributed over the entire surface of the material, and the remaining contact surface K of the covering material facing the adhesive layer amounting to maximum 30% of the surface A of the covering material.

The present invention relates to materials which are suitable for lining adhesive areas and which can subsequently be removed again substantially without residue.

The present invention more particularly relates to a material for lining surfaces of adhesive sanitary compositions, more particularly of toilet cleaning compositions in block form, which have been coated on at least one side, at least partly, with an adhesive paste.

The company Buck-Chemie GmbH of Herrenberg has developed adhesive pastes (attachment compositions) which can be used to adhere solid compositions in block form for the sanitary sector, such as rim blocks with one or more phases, fragrancing tablets, descaling tablets, and cleaning tablets, for example, directly on the surface of the toilet bowl. The flushing current gradually rinses off these compositions and also the attachment composition responsible for the affixment, as described in WO 2009/106220 A1.

These attachment compositions or adhesive compositions may comprise adhesion promoters from the group of the polyalkylene derivatives, the hydrogenated polystyrene derivatives, the silicone systems, the copolymers from the group of the monoalkyl esters of poly/methyl vinyl ethers/carboxylic anhydrides, the olefin homopolymers, and the copolymers of two or more olefins, it also being possible for the olefin homopolymers and copolymers to have been partly hydrogenated, partly oxidized, or further functionalized via grafting molecules, and from the group of the polyalkyleneimines, including those in alkoxylated form, the polyetheramines (alkoxylated amines), and the polyglycerol polyether alkylcarboxylic acids, or the polymers or derivatives comprising these polymer groups. Also possible as adhesion promoters are hydrophobic compounds such as oils, fats, or waxes, including those which are partly hydrogenated, silicone oils, and nonpolar solvents.

The viscosity of these attachment compositions is at least 30 Pa·s, measured using a Haake viscometer, plate/plate system, plate diameter 10 mm, at a shear rate of 2.62 s⁻¹ and 20° C.

These attachment compositions or adhesive compositions are themselves sufficiently sticky that even blocklike compositions of 40 g with dimensions of 20 mm×30 mm×60 mm, with a side face with dimensions of 30 mm×60 mm, can be adhered to the vertical surface of a toilet bowl and attach there with these compositions until eventually—in general after about 100 to 300 flushes—the sanitary composition has dissolved. The ratio between amount of adhesive composition and the mass of the blocklike composition may amount to between 0.005:1 and 0.2:1, preferably between 0.02:1 and 0.15:1, and more preferably between 0.03:1 and 0.1:1.

The attachment composition or adhesive composition itself is likewise gradually removed as flush water passes over it, meaning that no unsightly remnants remain in the toilet bowl.

These sanitary compositions featuring an adhesive layer could in principle be applied from the packaging—without the consumer coming into contact with the sanitary composition, the adhesive layer, or the toilet bowl.

A problem associated with the packaging of such adhesive sanitary compositions, however, is the lining of the adhesive surface, since customary protective films for such adhesive layers, such as siliconized or fluorinated films or sheets of paper, polyethylene or polypropylene, attach to the adhesive layer, and tear off part of that layer on detachment, so preventing effective attachment/adhesion of the sanitary composition to the toilet bowl over the composition lifetime of in general 100 to 300 flushes.

In order to allow these single-sidedly adhesive sanitary compositions to be stored and hygienically applied, therefore, special applicators have been developed, which are described in DE 10 2011 001 373 A1 and DE 10 2009 039 675 A1. These applicators serve simultaneously as packaging. With these applicators, the sanitary composition is held firmly or clamped in the applicator with the adhesive layer, in such a way that the adhesive layer does not perturb any surface and is therefore protected from unwanted sticking to the packaging. During application, the mounting/clamping of the sanitary composition in the applicator is undone and the sanitary composition is pressed against the toilet bowl, where it attaches.

These applicators do in fact produce hygienic and simple application and the desired protection of the adhesive layer. Disadvantages, however, are the relatively complex production and shape of an applicator of this kind for adhesive sanitary compositions, and the risk of the adhesive layer coming into contact with parts of the packaging during transport, as a result of movement within the packaging.

The sanitary compositions with adhesive layer could in that case be stored in the customary blister packs with blister card and, following detachment of the blister card, could be applied directly from the blister pack—by pressure on the blister pack, for example—in the toilet bowl, if a material were found that on the one hand protects the adhesive layer but on the other hand can be removed again substantially without residue from the adhesive layer of the sanitary composition before it is adhered.

Known from DE 1 594 075 A is an adhesive label having a coated, creped backing film which, in spite of a cut edge in common with the adhesive label, is said to be easily detachable. For this purpose, the teaching is that the backing film should be provided as a creped/corrugated structure which, under pressure or by rubbing or bending, can be stretched over the label or otherwise deformed in order to form a projection above the layer of adhesive, such a projection being easily grasped in order thereby to allow the backing film to be removed from the label.

The object of the present invention is to specify a material by means of which an attaching/adhesive layer can be lined and this material can be subsequently removed again from the adhesive layer substantially without residue.

This object is achieved by means of a liner material which has a substantially planar surface, with outwardly and/or inwardly directed structures being distributed randomly over the surface, the contact area facing in the direction of the adhesive layer amounting to not more than 30% of the surface area of the material.

Surprisingly it has been found that it is not, for instance, the entirely smooth surfaces conventionally used as nonstick coatings, but, instead, materials having outwardly or inwardly directed structures, that are suitable not only for lining the attaching/adhesive layers but can also be removed from these again substantially without residue.

Being removable substantially without residue means, for the purposes of the present invention, that following detachment of the liner material, at least 90%, preferably at least 99%, of the mass of the adhesive layer is detached again from the liner material.

By outwardly and/or inwardly directed structures on the surface are meant, for the purposes of the present invention, open or closed pores or openings on/in the surface, macroporous or honeycomblike structures. The effect of such structures is that only a fraction of the total area is available as contact area in the direction of the adhesive layer.

In contrast to DE 1 594 075 A, however, the structures are not to be made smooth by pressing, since that would further enlarge the contact area and would also make it more difficult for the material to be parted from the adhesive layer. Instead, the structures are intended to retain their form substantially under pressure as well, since the present invention is not concerned with equipping the liner material with a projecting corner, to allow it to be grasped more effectively; instead, the aim is to reduce the contact area overall.

The outwardly and/or inwardly directed structures on an otherwise linear surface may also be formed of fibers, as is the case, for example, with sheetlike felt or nonwoven materials. In that case, the fibers extending along the surface form the outwardly directed structures or, in another way of looking at it, the free spaces or “gaps” between the fibers form the structures directed inwardly away from the surface.

Such nonwovens or felts as well are structures distributed randomly over the surface of the material.

Sheetlike materials with outwardly directed, randomly distributed coating centers, such as emery paper, for example, can also be used as liner material.

The surface is substantially planar when it would be smooth or planar if the outwardly and/or inwardly directed structures were ignored.

To allow the liner material to be removed again substantially without residue from the entire adhesive layer over the entire area, the inwardly and/or outwardly directed structures ought to be distributed randomly over the total surface area of the material.

By “outwardly and/or inwardly directed structures distributed randomly over the surface” are meant structures which are distributed randomly over the whole surface. Projecting structures which have a preferential direction on the surface, as in the case, for example, of the corrugated protective backings known from DE 1 594 075 A, where the corrugations all extend in one direction in space, are not “structures distributed randomly over the surface”, since the individual corrugations run parallel to one another and therefore have a preferential direction.

As a result of the fact that the structures in accordance with the invention are distributed randomly on the surface, there is also no preferential direction on the surface formed by the outwardly and/or inwardly directed structures.

In the case of the inwardly directed structures, the remaining contact area is generally a two-dimensional coherent area, meaning that it is—in imagewise terms—possible to get from any point on the contact area to another point on the contact area without leaving the contact area. The contact area is therefore an interconnected, coherent or cross-linked area which is not deformable under pressure.

The fraction of the contact area relative to the surface area of the material amounts preferably to not more than 20% and more preferably to not more than 15%.

The surface area A of the material for the purposes of the present invention means the two-dimensional planar surface A=b×l, defined by the length l and width b of the piece of material.

The material surface in the sense of the present invention is the macroscopic surface of the material;

three-dimensional surfaces of pores or outwardly pointing structures are not taken into account when determining the material surface area A.

The contact area K of the material means the sum of the areas which lie against a planar adhesive layer.

The contact area K is determined in accordance with the invention by preparing a pad imprint of the (planar) surface of the liner material and carrying out determination, on the basis of the pad imprint, of the black fraction (i.e., the size of the contact area) relative to the size of the pad imprint (i.e., of the total surface area A).

Since the adhesive layer is highly viscous—the viscosity in general is at least 30 Pa·s—there is very little or no penetration by the adhesive into the pores of the liner material; instead, only the contact area K makes contact which can be determined by the partly colored area defined by the pad imprint—the pad ink likewise does not penetrate the pores.

Particularly good results have been obtained with materials having macroporous surfaces. Suitable materials having macroporous surfaces are, in particular, foams and foam materials having straight-cut surfaces (i.e., essentially “planar” surfaces), with the “planar surfaces” having open pores.

A surface is open-pore if it has a high open porosity and—viewed ideally—has a honeycomb structure.

The apparent density of the liner material of the invention, i.e., the density of the porous materials based on their volume including the pore spaces, ought to amount to at least 20 kg/m³, preferably at least 25 kg/m³, and more preferably at least 30 kg/m³.

The area of the open pores, i.e., the open area on the surface which is defined by the “outlining” by a pore, ought to be between 50 000 and 1 000 000 μm² and preferably between 200 000 and 400 000 μm². The width of the interconnect and the pores ought to be as small as possible.

The liner material of the invention is preferably a film.

The coating material of the invention can also be used in order to line surfaces of other adhesive materials temporarily, in order, for example, to protect the adhesive layer for later adhering.

An important end use of materials for lining adhesive layers, which can be removed again substantially without residue from the adhesive layer, the materials having a substantially planar surface with outwardly and/or inwardly directed structures distributed over the surface, with the remaining contact area K of the liner material in the direction of the adhesive layer amounting to not more than 30% of the surface area A of the liner material, are adhesive layers which comprise one or more adhesion promoters from the group of the polyalkylene derivatives, the hydrogenated polystyrene derivatives, the silicone systems, the copolymers from the group of the monoalkyl esters of poly/methyl vinyl ethers/carboxylic anhydrides, the olefin homopolymers, and the copolymers of two or more olefins, it also being possible for the olefin homopolymers and copolymers to have been partly hydrogenated, partly oxidized, or further functionalized via grafting molecules, and from the group of the polyalkyleneimines, including those in alkoxylated form, the polyetheramines (alkoxylated amines), and the polyglycerol polyether alkylcarboxylic acids, or the polymers or derivatives comprising these polymer groups, or the hydrophobic compounds such as oils, fats, or waxes, including those which are partly hydrogenated, silicone oils, and nonpolar solvents.

The stickiness of these adhesive layers is such that blocklike compositions of 40 g can be adhered thereto to the vertical surface of a toilet bowl, where they attach.

For use as liner material for such very sticky layers on blocklike sanitary compositions, it is possible to use not only the materials with randomly distributed inwardly and/or outwardly pointing structures but also materials having otherwise-oriented inwardly and/or outwardly pointing structures, examples being corrugated structures or creped surfaces.

The blocklike sanitary composition with adhesive/attaching layer and with the liner material lining the adhesive layer can be packaged and stored in a simple rectangular blister pack which has a blister card at the open side. For application, the blister card is first of all removed and then the liner material is peeled from the adhesive layer. Located on the open side of the blister pack, then, is the adhesive layer, which generally has a smooth surface. By means of pressure on the side of the pack that is opposite the open side, from the outside, the sanitary composition can then be pressed against the wall of the toilet bowl by the adhesive layer, within the bowl, where the composition with the adhesive layer attaches.

The liner material of the invention is also suitable, moreover, for lining adhesive layers which are not entirely smooth. In a case of this kind, the liner material can be detached even more easily, since in this case the contact between liner material and adhesive layer is reduced not only by a reduction in the possible contact area on the part of the liner material, but also through a reduction in the maximum contact area on the part of the adhesive layer.

In the drawing

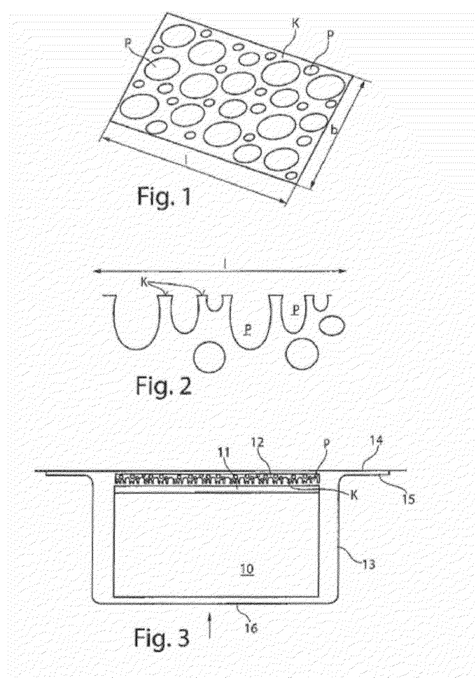

FIG. 1 shows a plan view of a foam-material surface as liner material,

FIG. 2 shows a side view of the foam-material surface from FIG. 1, and

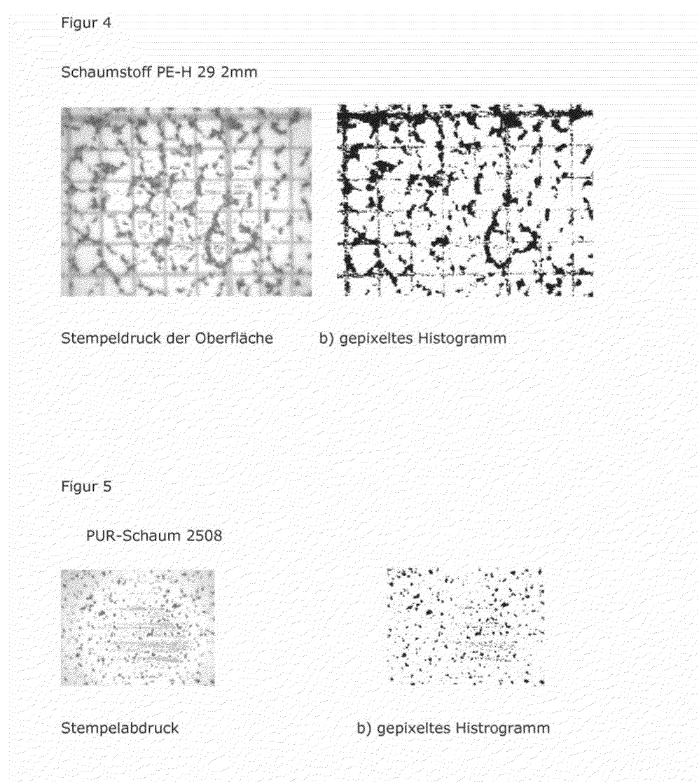

FIG. 3 shows a sanitary composition with adhesive layer and liner material in a blister pack.

Illustrated in FIG. 1 is a foam block with a straight cut face in plan view. The straight cut face of the foam block, i.e., the surface, is defined by the width b and the length l, surface area A=l×b.

Looked at more closely, the surface has a multiplicity of randomly distributed open pores P, and so only part of the surface area A, namely the contact area K illustrated in FIG. 2, ultimately forms a surface which actually contacts the adhesive layer. The fraction of the contact area K relative to the surface area A ought to amount to less than 30%. Illustrated in FIG. 3 is a blocklike solid sanitary composition 10, which is coated with an adhesive layer 11. The adhesive layer 11 ought to have approximately the same thickness over the entire sanitary composition 10. The layer thickness of the adhesive layer is generally about 0.5 to 5 mm, preferably between 1 mm to 3 mm. The sanitary composition 10 is located in a blister pack 13 and bears against the blister pack 13 with its uncoated sides. The outwardly pointing side of the adhesive layer 11 of the composition 10 is lined over its whole area with the liner film 12 of the invention. Located on the open side of the blister pack 10 is a blister card 14, which is bonded adhesively to the edges 15 of the blister pack 10.

If the blister card 14 and subsequently the liner film 12 are removed, the composition 10 with the adhesive layer 11 can be stuck into the toilet bowl by pressure on the side 16 of the blister pack that is opposite the opening, in the arrow direction, without the consumer coming into direct contact with the toilet bowl or with the sanitary composition.

The invention is described in more detail below with reference to working examples and comparative experiments.

### 1. Experiments on the Suitability of Different Materials for Lining Adhesive Layers:

A nozzle is used to apply a defined amount of the attachment paste in a constant layer thickness to a rectangular WC block with dimensions of 30×60×15 mm.

The composition of the attachment paste is as follows:

| | Range | Preferred range |
|---|---|---|
| Constituent | [%] | [%] |
| Xanthan | 0.1-2 | 1-2 |
| Eltesol SCS93 | 1-10 | 5-7 |
| Tensopol USP94 | 20-60 | 40-55 |
| Versagel M1600 | 20-60 | 40-55 |

The respective liner material, the weight of which has been determined beforehand, is now placed loosely onto the block, coated with attachment paste, and the lined block is covered with a marble slab weighing around 130 g, for better weight distribution, and then pressed on with a weight weighing 500 g.

The liner material lies on the layer of attachment paste by a substantially planar surface.

After 60 seconds, the marble slab is removed again and the liner film is peeled from the attachment paste.

The difference between the weight of the liner film before (“test strip weight before”) and after the experiment (“test strip weight after”) gives the amount of attachment paste which has remained on the film during peeling of the film. The greater the difference found for the material in question, the more attachment composition remains attaching to the liner material after peeling, and the less suitable is the material in question.

TABLE 1
Table 1 compiles the amount of paste (“difference”) adhering
after peeling for a variety of materials:

| | Test strip weight | | |
|---|---|---|---|
| | (g) | | Difference |
| Liner material | Before | After | (g) |
| Aluminum foil | 0.18 | 0.73 | 0.55 |
| Foam | 1.33 | 1.35 | 0.02 |
| Plexiglas sheet | 21.90 | 23.21 | 1.31 |
| Silicone paper | 0.72 | 1.67 | 0.95 |
| 9120 SM¹ | | | |
| 3M self-wetting | 2.50 | 2.59 | 0.09 |
| film (77195W) | | | |
| Teflon-coated | 2.14 | 3.22 | 1.08 |
| fabric (Mure & | | | |
| Peyrot) | | | |
| Ratioform oil | 0.42 | 0.75 | 0.33 |
| paper | | | |
| Laminating film² | | | |
| Side A | 0.49 | 0.99 | 0.50 |
| Side B | 0.50 | 0.94 | 0.44 |

¹this material is normally used as backing material for self-adhesive labels.
²thickness 80 μm, high transparency, consists of two films, one of polyethylene terephthalate PET and one of polypropylene.

The results in table 1 show that foams, in contrast to conventional liner materials, can be removed from the adhesive layer with far less residue.

2. Experiment with Liner Materials with Structured Surface:

In order to investigate further the connection between the by the outwardly and/or inwardly directed structures on the surface, which to a rough or microscopically uneven surface and to detachability of the liner material, the experiments under 1. were repeated below with different foam materials and other materials having a structured surface, such as crepe tape and emery paper. The result is illustrated in table 2 below:

TABLE 2

| | Test strip weight | | | Apparent |
|---|---|---|---|---|
| | (g) | | Difference | density |
| Liner material | Before | After | (g) | (kg/m³) |
| Foam yellow PU | 1.70 | 1.72 | 0.02 | |
| GR6290 | | | | |
| Foam 3030 PU | 0.89 | 0.91 | 0.02 | |
| Foam VB 120 | 3.96 | 3.98 | 0.02 | |
| (composite) | | | | |
| Foam 4R 5560 PE | 1.49 | 1.50 | 0.01 | |
| Tesa crepe tape | 3.04 | 3.06 | 0.02 | |
| Emery paper | 1.99 | 2.29 | 0.30 | |
| (Bauhaus) | | | | |
| 60 grade | | | | |
| Decorative | | | | |
| felt tape | | | | |
| Side A | 2.20 | 2.22 | 0.02 | |
| Side B | 2.04 | 2.29 | 0.05 | |
| Dimer PU-PE | 0.33 | 0.39 | 0.06 | 35 |
| Collar 23510* | | | | |
| 2 mm anthracite | | | | |
| Timepack | 0.30 | 0.31 | 0.01 | 33 |
| PE-H 30** | | | | |
| 2 mm Black | | | | |
| Timepack PE-K | 0.27 | 0.27 | 0.00 | 29 |
| 29*** | | | | |

*Collar 2254, 2508 and 23510: PU polyethers available from W. Dimer GmbH, Laufenburg.
**PE-H 30, available from Timepack GmbH, Korb.
***PE-K 29, physically crosslinked slabstock foam, available from Timepack GmbH, Korb.
PE-K 29 and PE-H 30 are both virtually identical polyethylenes; PE-K 29 is crosslinked physically and PE-H 30 chemically.
PE-H 30 has finer pores and a smoother surface than PE-K 29.

Table 2 shows that good results are achieved with foams made of PU or PE, with crepe tape, or with decorative felt tape.

Further experiments carried out with foams as liner material also demonstrate that the best results achieve with foams of polyethylene or PU polyether having an apparent density above 25 kg/m³. Good results were also achieved with felt tapes and with crepe paper.

### 3. Long-Term Tests

The WC blocks coated with the attachment paste, with the liner materials as per experiments 1 and 2, are stored in a conditioning cabinet for four weeks, in each case for 24 hours in alternation at 5° C. and a relative humidity of 60% and thereafter at a temperature of 40° C. with 60% humidity, and after four weeks the detachability of the liner material is tested. In spite of extreme conditions to which the samples of material were subject, only a small amount of the attachment paste remained attaching to the investigated samples of PE-K 29 and PE-H 30, the felt, and the PU foam Collar 2508 and 23510.

These experiments demonstrate that the liner materials of the invention can be detached again substantially without residue from the adhesive layer even after long storage under extreme conditions.

| | |
|---|---|
| Long-term test 2 | Start date: 27 Feb. 2013 |
| Settings: | End date: 1 Apr. 2013 |
| 24 hours 5° C., 60% rel. | Weight per WC block about |
| humidity | 620 g |
| 24 hours 40° C., 60% rel. | |
| humidity | |

TABLE 3

| | Test strip weight | | |
|---|---|---|---|
| | (g) | | Difference |
| Material Name | Before | After | (g) |
| DIMER PU Collar 2508 black | 0.51 | 0.73 | 0.22 |
| DIMER PU Collar 2254 anthracite | 0.23 | 0.33 | 0.10 |
| DIMER PU Collar 23510 anthracite | 0.32 | 0.36 | 0.04 |
| Timepack PE H-30 2 mm black | 0.32 | 0.32 | 0.00 |
| Timepack PE H-30 4 mm black | 1.07 | 1.09 | 0.02 |
| Timepack PE K-29 2 mm black | 0.26 | 0.28 | 0.02 |
| Timepack PE K-29 4 mm black | 0.66 | 0.66 | 0.00 |

4. Testing of the Detachability of the Inventive Liner Materials from Other Adhesive or Attaching Layers:

The PE-K-29, 2 mm and PE-H-30 liner film was applied to different adhesive layers, and pressed on, in accordance with experiment 1. After a minute, the liner film was peeled off again and the residue of the adhesive layer on the liner film was ascertained.

The results of the experiment are set out in table 4a, b and c below.

TABLE 4a
Application of different pastes to PE-K-29, 2 mm

| | | Raw | After | Residue | |
|---|---|---|---|---|---|
| | | material | treatment | paste | Attach- |
| # | Material | in g | in g | in mg | ment |
| 1 | 20130313_V22 | 0.22 | 0.222 | 2 | None |
| 2 | 20130313_V19 | 0.228 | 0.231 | 3 | None |
| 3 | PROBAU Aqua-seal | 0.23 | 0.241 | 11 | None |
| 4 | MEM assembly | 0.241 | 0.252 | 11 | None |
| | adhesive | | | | |
| 5 | UHU assembly | 0.23 | 0.255 | 25 | None |
| | adhesive | | | | |
| 6 | PROBAU assembly | 0.22 | 0.247 | 27 | None |
| | adhesive | | | | |
| 7 | Sika Sikaflex- | 0.242 | 0.274 | 32 | None |
| | 11FC | | | | |
| 8 | PROBAU acrylic | 0.22 | 0.257 | 37 | None |
| | sealant | | | | |
| 9 | 20130313_V18.4 | 0.229 | 0.269 | 40 | None |
| 10 | PROBAU building | 0.235 | 0.346 | 111 | None |
| | silicone | | | | |
| 11 | PROBAU bitumen | 0.239 | 0.358 | 119 | Slight |
| | roof and joint seal | | | | |
| 12 | 20130313_Probe | 0.232 | 0.383 | 151 | Slight |
| | Nr. 106 | | | | |
| 13 | MEM chimney and | 0.219 | 0.424 | 205 | Slight |
| | oven | | | | |
| 14 | 20130313_V13 | 0.228 | 0.464 | 236 | Slight |
| 15 | 20130313_Probe | 0.224 | 0.634 | 410 | Strong |
| | No. 108 | | | | |
| 16 | 20130313_V18.8 | 0.243 | 1.397 | 1154 | Strong |

Attachment:

### None: <0.35 mg

Slight: 0.35<residue<0.5 mg

### Strong: >=0.5 mg

Lined area: 30 mm×60 mm

TABLE 4b
Application of different pastes to PE-H-30

| | | Raw | After | Residue | |
|---|---|---|---|---|---|
| | | material | treatment | paste | Attach- |
| # | Material | in g | in g | in mg | ment |
| 1 | 20130313_V22 | 0.169 | 0.169 | 0 | None |
| 2 | 20130313_V19 | 0.182 | 0.183 | 1 | None |
| 3 | 20130313_V18.4 | 0.198 | 0.227 | 29 | None |
| 4 | 20130313_Probe | 0.206 | 0.377 | 171 | Slight |
| | No. 106 | | | | |
| 5 | Sika Sikaflex- | 0.188 | 0.42 | 232 | Slight |
| | 11FC | | | | |
| 6 | 20130313_Probe | 0.209 | 0.467 | 258 | Slight |
| | No. 108 | | | | |
| 7 | 20130313_V18.8 | 0.199 | 0.826 | 627 | Strong |
| 8 | PROBAU building | 0.168 | 1.091 | 923 | Strong |
| | silicone | | | | |
| 9 | PROBAU Aqua-seal | 0.189 | 1.258 | 1069 | Strong |
| 10 | 20130313_V13 | 0.185 | 1.421 | 1236 | Strong |
| 11 | MEM chimney and | 0.18 | 1.721 | 1541 | Strong |
| | oven | | | | |
| 12 | PROBAU acrylic | 0.165 | 2.799 | 2634 | Strong |
| | sealant | | | | |
| 13 | PROBAU bitumen | 0.182 | 3.282 | 3100 | Strong |
| | roof and joint seal | | | | |
| 14 | UHU assembly | 0.166 | 4.166 | 4000 | Strong |
| | adhesive | | | | |
| 15 | MEM assembly | 0.169 | 4.968 | 4799 | Strong |
| | adhesive | | | | |
| 16 | PROBAU assembly | 0.166 | 8.745 | 8579 | strong |
| | adhesive | | | | |

### Table 4c: Composition of the Pastes Investigated

(See final page of description)

A comparison of the experiments with the PE-K-20 and PE-H-30 film shows that the materials investigated are adsorbed to different strengths on the films, despite the two films being of very similar materials, namely PE.

This is attributed firstly to different structural effects, namely the ratio of contact area to surface area and/or the sum total of all interconnect areas to the sum total of all open pore areas.

A key role is also played, moreover, by the chemistry of the adhesive materials. Nonpolar matrix elements (Polyvest 800S or components such as Versagel) lead to slight attachment, while polar matrix elements (such as Lupasols or Jeffamines) lead to attachment which is often stronger.

The viscosity of the adhesive material also has an influence. The less viscous the adhesive material, the greater the extent to which it penetrates the pores and the greater the attachment surface area.

### 5. Determination of the Fraction of the Contact Area K to the Surface Area A

In order to determine the ratio between contact area and surface area of the material for the liner materials investigated, a pad imprint of the surface of the material on mm paper is prepared. This imprint is photographed by Delock Pen Scope. The images are processed using image-processing software in order for the black fraction to then be determined via the histogram. For this purpose, the photographs are converted into black/white values and then pixelated. Ten measurements are carried out in each case, and the values are subsequently averaged.

The white reference value was measured separately with a pad on white paper; the grid accounts for about 2.5% of the total blackening.

Table 5 below summarizes the ratio of contact area to surface area, determined in this way, for the preferred foam materials PE-K-29 2 mm fine and coarse, PE-H-30 PU foam, and PU foam 2508—averaged over ten measurements. In order to investigate the effect of the halftoning, the experiment was carried out both with fine halftoning “fine” and with coarse halftoning “coarse”. Likewise determined in this table, as a comparison, is the K/A ratio for laminating film having a smooth surface on the inside and a coated surface on the outside.

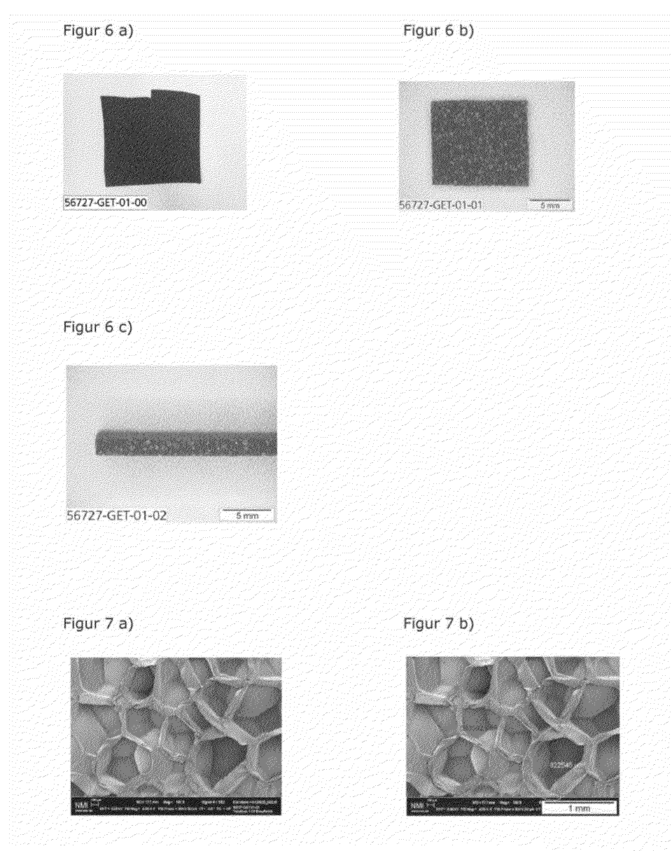

The depictions of the originally padded areas and of the histograms determined from them are shown hereinafter in FIGS. 4 and 5.

TABLE 5

| | Ratio of contact area/ |
|---|---|
| | surface area (%) Averaged |
| Film | over 10 measurements |
| PE-K-29 2 mm (measured on | 9.1 |
| white paper) | |
| PE-K-29 2 mm fine (see | 11.7 |
| FIG. 4) | |
| PE-K-29 2 mm coarse | 11.1 |
| PE-H-30 2 mm | * |
| PU foam (measured on | 6.2 |
| white paper) see FIG. 5 | |
| Laminating film (non- | |
| porous = inside; coated = | |
| outside) | |
| Inside | 19.5 |
| Outside | 46.9 |

### 6. SEM Investigations of a PU Foam for Pore Size and Interconnect Width

At the NMI (Institute of Natural Sciences and Medicine at Tübingen University) at Reutlingen, SEM investigations were carried out on a black PU foam (PE-K-29), in order to investigate the topography. In the foreground was the statistical area of the open pores on the surface in relation to the width of the surrounding interconnects. For this purpose, both the surface area of the foam and the side area of the foam were investigated, and the open pore area and areas of the surrounding interconnects were measured.

The sample was documented in the as-received state.

Two pieces were made from the foam. On the piece serving for documentation of the side area, a scalpel was used to produce a new cut surface. The samples produced were adhered using C-conductive tabs of aluminum sample plates, and then sputtered with a conductive layer of Au/Pd.

FIG. 6 shows the light micrograph

a) of the overview view, b) of the sample produced in plan view, and c) of the side area of the sample produced.

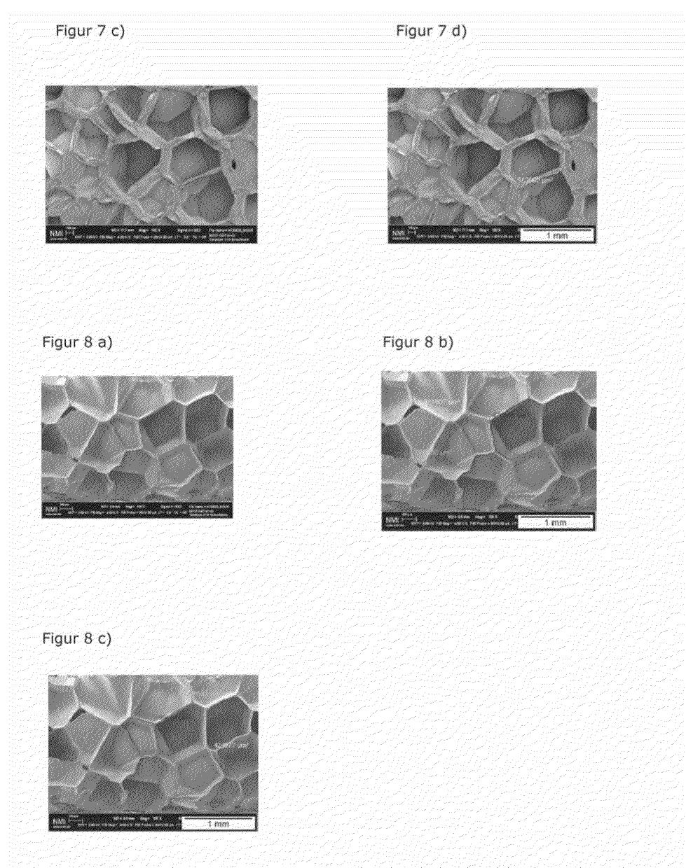

FIG. 7a) shows the SEM images (scanning electron microscope) in plan view. Apparent are pores with folded-over, flat-lying interconnects on the surface, and an indication of the hexagonal shape of the pores.

FIG. 7b) shows a detail from FIG. 7a. The measurement of the left-hand pore gives an open area of 394 126 μm² and an interconnect area of 583 592 μm²-391 126 μm²=1 894 676 μm². This produces a ratio of open area of this pore to the interconnect area of this pore of 1:0.48.

For the right-hand pore, the open pore area is 388 952 μm², the interconnect area is 822 548 μm²-388 952 μm²=433 596 μm², and hence the ratio of pore to interconnect is 1:0.11.

FIG. 7c) shows a further SEM micrograph of the surface in plan view, with pores having folded-over, flat-lying interconnects on the surface and, on an outline basis, the hexagonal form of the pores, and FIG. 7d) shows the evaluation of the pore investigated from FIG. 7c. Accordingly, this pore has an area of 354 319 μm², an interconnect area of 209 643 μm², and a pore:interconnect ratio of 1:0.59.

FIG. 8a) shows the side area with pores having vertical interconnects on the surface. The hexagonal shape of the pores is generally also evident. FIG. 8b) shows the detail from figure a) for the measurements for the left- and right-hand pores. For the left-hand pore, the pore area is calculated to be 298 880 μm², the interconnect area 32 727 μm², and the pore:interconnect ratio=1:0.11. For the right-hand pore, the pore area is 476 051 μm², the interconnect area is 37 494 μm², and the pore:interconnect area ratio is 1:0.08.

FIG. 8c) shows a further detail from FIG. 8a) with evaluation. For the left-hand pore, the area is 199 614 μm², the interconnect area is 35 391 μm², and the pore:interconnect ratio is 1:0.18. For the right-hand pore, the area is 388 641 μm², the interconnect area is 36 336 μm², and the pore:interconnect area ratio is 1:0.09.

These investigations show that in the case of an undamaged surface, namely the freshly scalpel-cut side area of the foam, the ratio of open pore area:interconnect area is below 1:0.2. In the case of a surface which—like the facing side of the foam—has already been exposed to a pressure, the interconnect surfaces fold over and therefore increase the contact area.

TABLE 4c

| | | | | | 20130313_Probe | | 20130313_Probe | | | | | | | |
|---|---|---|---|---|---|---|---|---|---|---|---|---|---|---|
| | 20130313_V18.4 | | 20130313_V18.8 | | Nr.106 | | Nr.108 | | 20130313_V13 | | 20130313_V19 | | 20130313_V22 | |
| | Initial | | Initial | | Initial | | Initial | | Initial | | Initial | | Initial | |
| | mass in | | mass in | | mass in | | mass in | | mass in | | mass in | | mass in | |
| | g | Wt. % | g | Wt. % | g | Wt. % | g | Wt. % | g | Wt. % | g | Wt. % | g | Wt. % |
| Tensopol | 8 | 49.597 | 8 | 49.66 | 8 | 36.12 | 12 | 45.89 | 15.72 | 15.72 | 38.4 | 38.44 | 40.72 | 40.72 |
| USP 94 | | | | | | | | | | | | | | |
| Kelzan ASX | 0.16 | 0.992 | 0.16 | 0.99 | 0.16 | 0.72 | 0.16 | 0.61 | 1.07 | 1.07 | 0.7 | 0.70 | 1.02 | 1.02 |
| Lupasol SK | 5.92 | 36.702 | | 0.00 | | 0.00 | | 0.00 | | 0.00 | | | | 0 |
| Lupasol P | | | 5.9 | 36.62 | | 0.00 | | 0.00 | | 0.00 | | | | 0 |
| Orange Fun | 2.05 | 12.709 | 2.05 | 12.73 | 2.05 | 9.26 | 2.05 | 7.84 | 13.14 | 13.14 | 9.7 | 9.71 | 10.42 | 10.42 |
| Marlinat | | | | | 4.5 | 20.32 | 4.5 | 17.21 | | 0.00 | | | | |
| 242/90T | | | | | | | | | | | | | | |
| Emanon XLF | | | | | 1.5 | 6.77 | 1.5 | 5.74 | | 0.00 | | | | |
| Jeffamine | | | | | 5.94 | 26.82 | | 0.00 | | 0.00 | | | | |
| T 5000/ | | | | | | | | | | | | | | |
| (triamine) | | | | | | | | | | | | | | |
| Jeffamine | | | | | | | 5.94 | 22.72 | 32.26 | 0.00 | | | | |
| ST-404 | | | | | | | | | | | | | | |
| (diamine) | | | | | | | | | | | | | | |
| Polyvest 800S | | | | | | | | | 37.8 | 37.80 | 31.3 | 31.33 | 30.96 | 30.96 |
| Calcium sulfate | | | | | | | | | | 0.00 | 14.9 | 14.91 | | |
| Bentonite | | | | | | | | | 32.26 | 32.26 | | | 11.69 | 11.69 |
| Aerosil 300 | | | | | | | | | | | 4.9 | 4.90 | 5.19 | 5.19 |
| Total | 16.13 | 100 | 16.11 | 100 | 22.15 | 100 | 26.15 | 100 | 99.99 | 100 | 99.9 | 100 | 100 | 100 |
| Notes | Highly tacky | | Flowable yellow | | Sag-resistant | | Sag-resistant | | Sag-resistant | | Solid white | | Solid gray mass | |
| | white mass | | mass | | pink mass | | white mass | | gray mass | | mass | | | |
| Polar fraction | | 87.291 | | 87.27 | | 90.74 | | 92.16 | | 49.05 | | 58.26 | | 58.62 |

1. The use of a material for lining adhesive layers, which material can be removed again substantially without residue from the adhesive layer,
characterized in that the material has a substantially planar surface with outwardly and/or inwardly directed structures distributed over the surface, the inwardly and/or outwardly directed structures being distributed randomly over the total surface area of the material and the outwardly and/or inwardly directed structures on the surface being open or closed pores or honeycomblike structures, the remaining contact area K of the liner material in the direction of the adhesive layer amounting to not more than 30% of the surface area A of the liner material.

2. (canceled)

3. The use as claimed in claim 1, characterized in that the surface is macroporous and/or open-pore.

4. The use as claimed in claim 1, characterized in that the fraction of the contact area K relative to the total area A of the material amounts to not more than 20% and more preferably not more than 15%.

5. The use as claimed in claim 1, characterized in that the apparent density of the liner material amounts to at least 20 kg/m³, preferably at least 25 kg/m³, and more preferably from at least 30 kg/m³.

6. The use as claimed in claim 1, characterized in that the average area of the open pores on the surface amounts to between 50 000 μm² and 1 000 000 μm², preferably between 200 000 μm² and 400 000 μm².

7. The use as claimed in claim 1, characterized in that the liner material is a film.

8. The use of the material as claimed in claim 1 for lining an attaching/adhesive layer which comprises one or more adhesion promoters from the group of the polyalkylene derivatives, the hydrogenated polystyrene derivatives, the silicone systems, the copolymers from the group of the monoalkyl esters of poly/methyl vinyl ethers/carboxylic anhydrides, the olefin homopolymers, and the copolymers of two or more olefins, it also being possible for the olefin homopolymers and copolymers to have been partly hydrogenated, partly oxidized, or further functionalized via grafting molecules, and from the group of the polyalkyleneimines, including those in alkoxylated form, the polyetheramines (alkoxylated amines), and the polyglycerol polyether alkylcarboxylic acids, or the polymers or derivatives comprising these polymer groups, or the hydrophobic compounds such as oils, fats, or waxes, including those which are partly hydrogenated, silicone oils, and nonpolar solvents.

9. The use of the material for lining adhesive layers, which material can be removed again substantially without residue from the adhesive layer,
characterized in that the material has a substantially planar surface with outwardly and/or inwardly directed structures distributed over the surface, and the remaining contact area K of the liner material in the direction of the adhesive layer amounting to not more than 30% of the surface area A of the liner material,
and where the adhesive layer comprises one or more adhesion promoters from the group of the polyalkylene derivatives, the hydrogenated polystyrene derivatives, the silicone systems, the copolymers from the group of the monoalkyl esters of poly/methyl vinyl ethers/carboxylic anhydrides, the olefin homopolymers, and the copolymers of two or more olefins, it also being possible for the olefin homopolymers and copolymers to have been partly hydrogenated, partly oxidized, or further functionalized via grafting molecules, and from the group of the polyalkyleneimines, including those in alkoxylated form, the polyetheramines (alkoxylated amines), and the polyglycerol polyether alkylcarboxylic acids, or the polymers or derivatives comprising these polymer groups, or the hydrophobic compounds such as oils, fats, or waxes, including those which are partly hydrogenated, silicone oils, and nonpolar solvents.

10. The use as claimed in claim 1 or 9, characterized in that the adhesive layer has a thickness of between 0.5 mm and 5 mm, preferably between 1 mm and 3 mm.

11. The use as claimed in claim 1 or 9, characterized in that the adhesive/attaching layer has a viscosity of at least 30 Pas, measured using a Haake viscometer, plate/plate system, plate diameter 10 mm, at a shear rate of 2.62 s⁻¹ and 20° C.

12. The use as claimed in claim 1 or 9, characterized in that the stickiness of the adhesive layer is such that blocklike compositions of 40 g can be adhered to the vertical surface of a toilet bowl and attach there using said adhesive layer.
